(19) United States
(12) Patent Application Publication
(10) Pub. No.: US 2015/0037123 A1
(43) Pub. Date: Feb. 5, 2015

(54) PIT-LESS TRUCK DUMPER

(71) Applicant: James Robert Hobbs, Springville, TN (US)

(72) Inventor: James Robert Hobbs, Springville, TN (US)

(21) Appl. No.: 13/957,456

(22) Filed: Aug. 2, 2013

(51) Int. Cl. B65G 67/48

(52) U.S. Cl. CPC B65G 67/48; B65G 2814/03; B65G 2814/0217
USPC 414/362; 414/421; 414/583

(57) ABSTRACT

The truck dumper includes a low profile truck platform built atop a flat concrete slab and lifted by a pair of hydraulic cylinders. The truck platform has a deck suspended between a pair of side I beams resting atop the bottom flanges of the I beams. The low profile truck platform eliminates the need for a below grade lift pit. The truck dumper also includes a wheel chock assembly integrated into the truck platform.

This invention relates to apparatus for pivoting trucks and tractor trailers to dump the contents of the same into storage pits and containers.

### BACKGROUND AND SUMMARY OF THE INVENTION

“Truck dumpers” or “truck tippers” are large mechanical apparatus used to unload trucks and tractor trailers carrying a variety of grains, produce and bulk granular materials. Truck dumpers use elongated truck platforms and hydraulic cylinders to physically lift both the tractor and the connected trailer to unload the trailer's contents. Conventional truck dumpers can lift and pivot tractor trailers of lengths up to 85 feet with a gross vehicle weight of 140,000 pounds to angles up to 63 degrees in only a few minutes. Cross gates and wheel chocks prevent the truck and/or trailers from rolling off the truck platform as it is being lifted. In conventional truck dumper designs, the pivoting truck platforms are built atop lift pits buried below road grade. While the below road grade lift pits accommodate the large hydraulic lift cylinders that raise the platform, excavation of the driveway and ground around the truck dump is required for normal truck ingress and egress.

The present invention provides a truck dumper that eliminates the need for a below grade lift pit. The truck dumper of this invention includes a low profile truck platform built atop a flat concrete slab and lifted by a pair of hydraulic cylinders. The truck platform has a deck suspended between a pair of side I-beams resting atop the bottom flanges of the I beams. The low profile design of the truck platform eliminates the need for a below grade lift pit, without compromising structural integrity of the truck dumper.

The truck dumper of this invention also includes a wheel chock assembly integrated into the truck platform. The wheel chock assembly includes a pivoting chock deck directly connected to the platform pivot shaft and a separate pair of hydraulic cylinders that move the chock platform between a lowered position and a raised position. In the lowered position, the chock deck lays flat forming part of the suspended truck deck. In the raised position, the chock deck is pivoted upward about an axial shaft so that the edge of the chock platform abuts the rear wheels of the truck to act as a wheel chock. The pivoting chock platform is physically braced by the abutment of a sub-frame cross member against the flanges of the large side I-beams. The integrated wheel chock assembly provides a sturdy mechanical wheel stop without extensive structural bracing.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is a perspective view of an embodiment of the truck dumper of this invention;

FIG. 2 is an end view of the truck tipper of FIG. 1;

FIG. 3 is a partial perspective view of the pivot end of the truck dumper of FIG. 1 showing the wheel block assembly;

FIG. 4 is a partial top view of the pivot end of the truck dumper of FIG. 1 and the wheel block assembly;

FIG. 5 is a partial side view of the pivot end of the truck dumper of FIG. 1 and the wheel block assembly in the lowered position;

FIG. 6 is a partial side view of the pivot end of the truck dumper of FIG. 1 and the wheel block assembly in the raised position;

FIG. 7 is a side view of the truck dumper of FIG. 1 showing a truck moving onto the deck;

FIG. 8 is a side view of the truck dumper of FIG. 1 showing the wheel block in the raised position to hold the truck in place on the deck; and

FIG. 9 is a side view of the truck dumper of FIG. 1 showing the deck raised to dump the contents of the truck.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

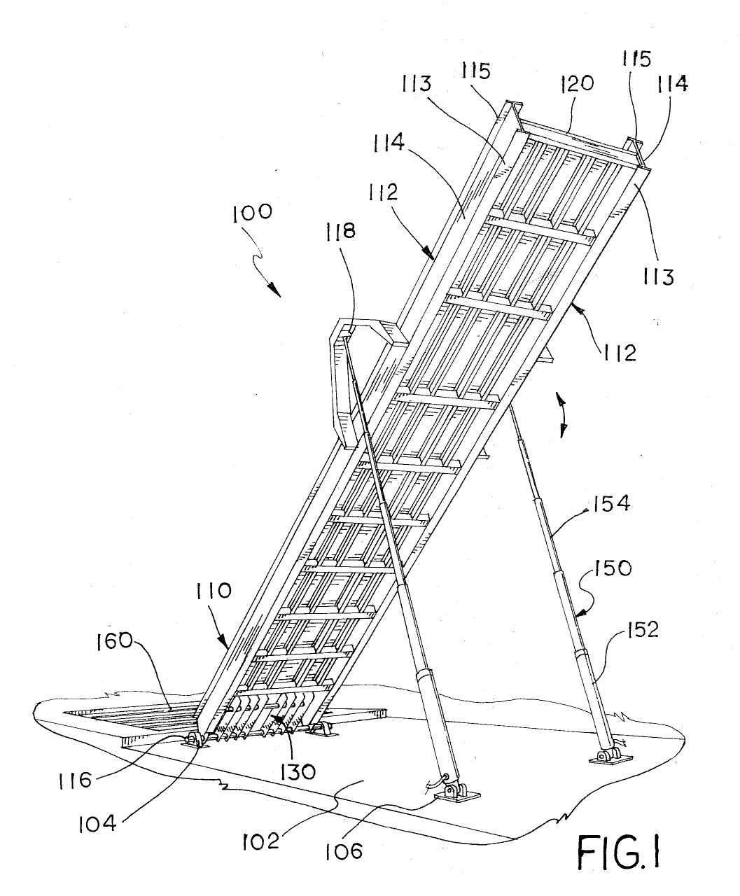

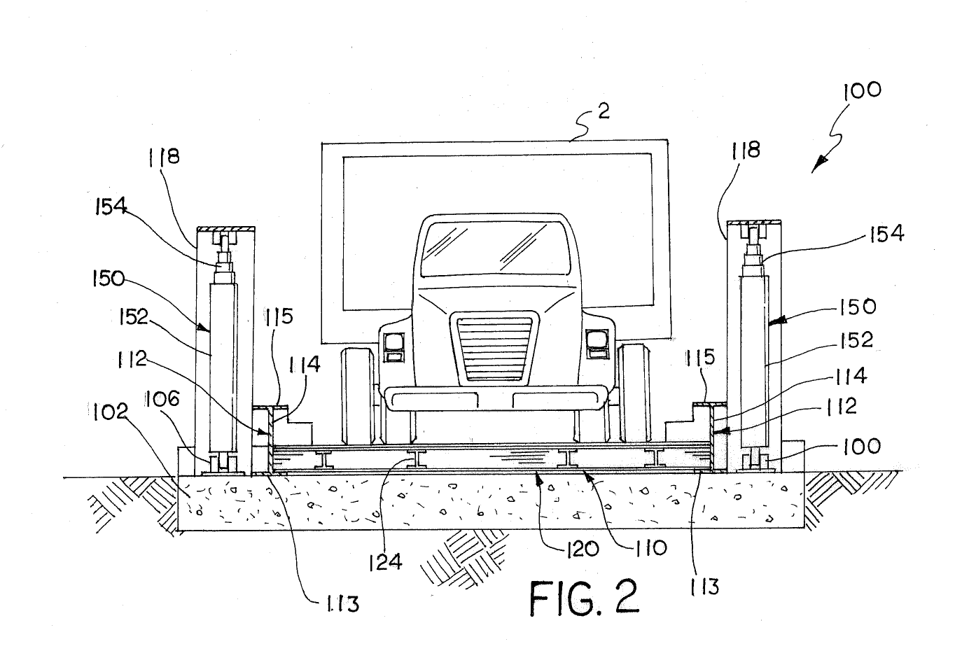

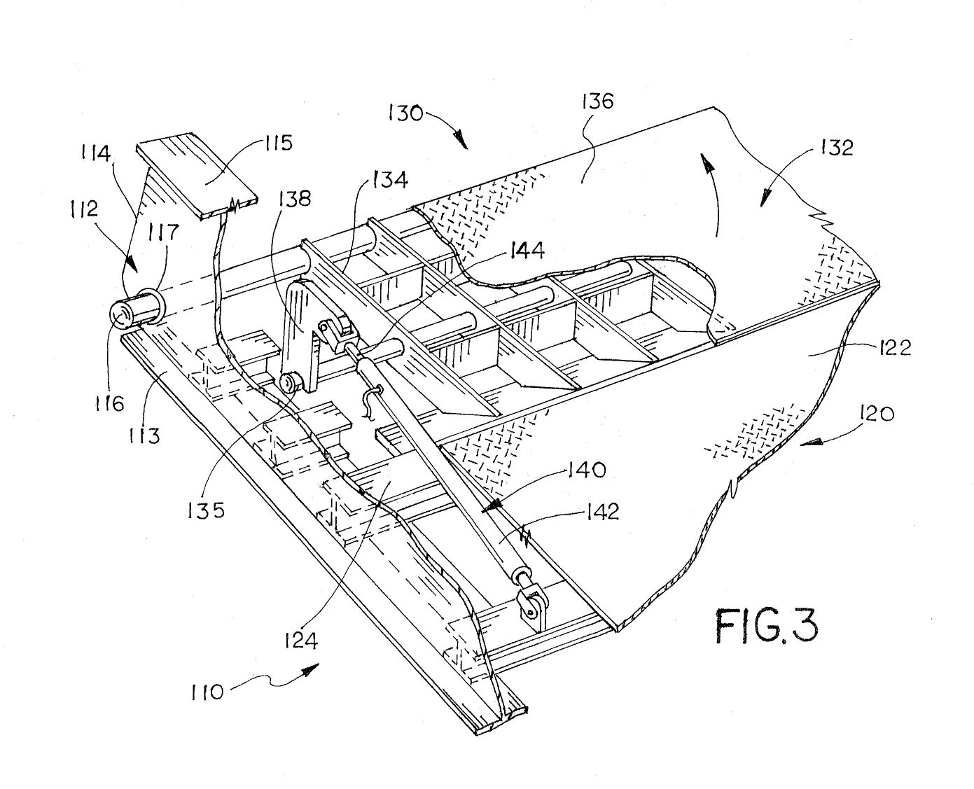

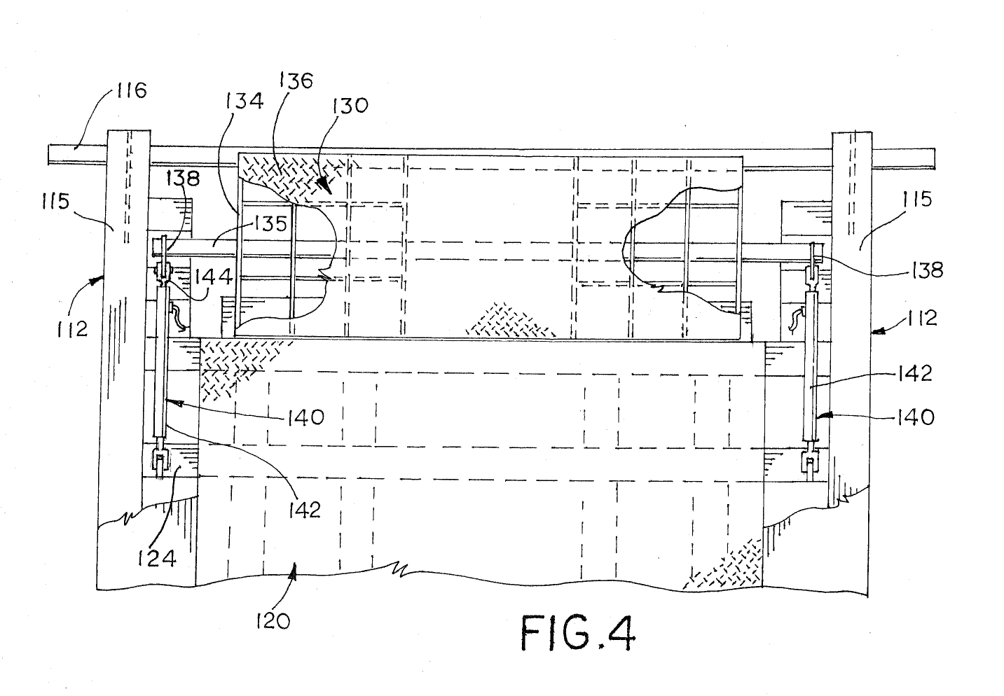

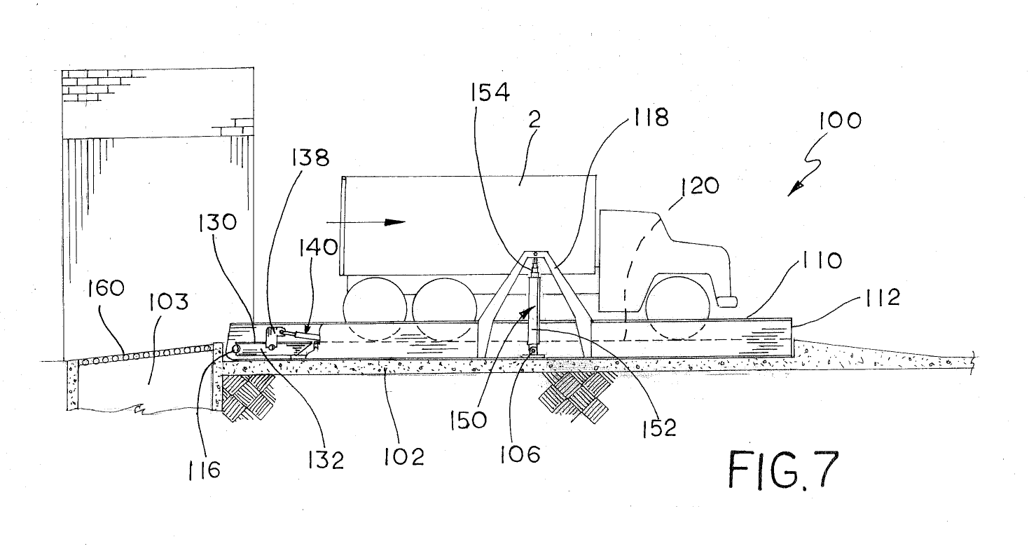

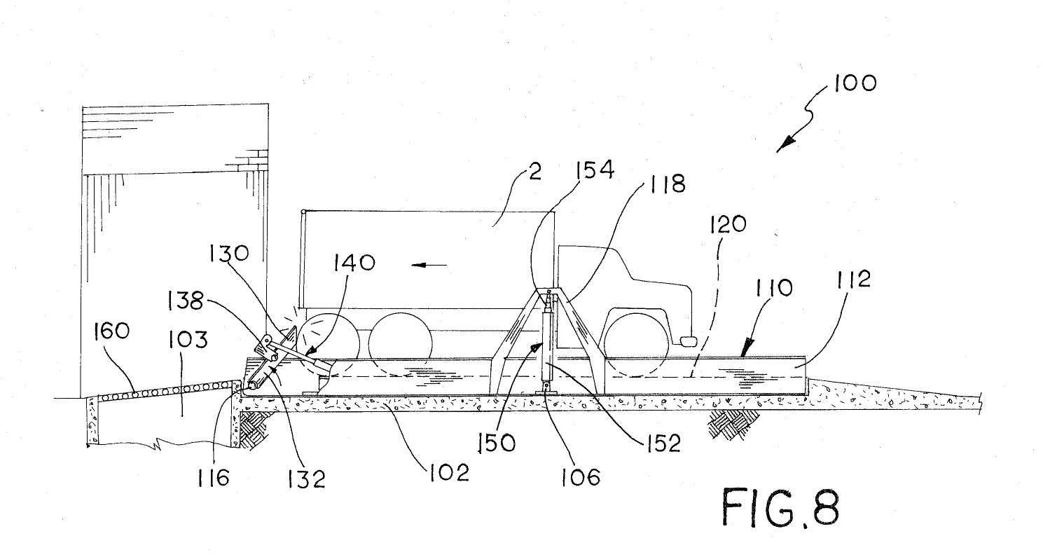

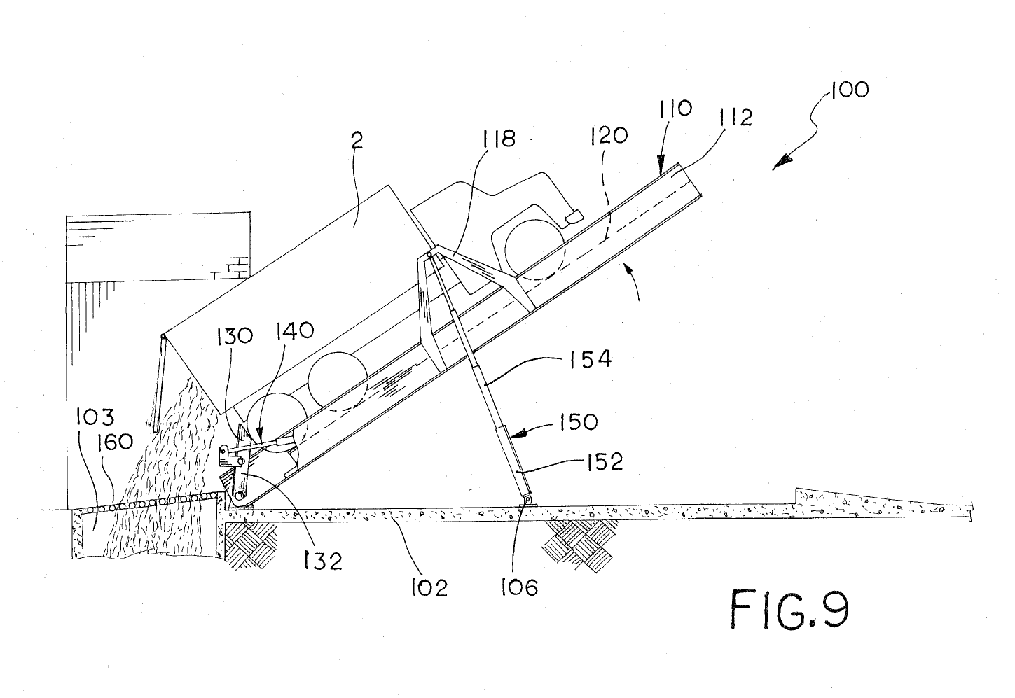

Referring now to the drawings, FIGS. 1-9 illustrate an embodiment of the truck dumper of this invention, which is designated generally as reference number 100. Truck dumper 100 is illustrated as a “drive-through” style truck dumper, but may be configured, modified or adapted within the teaching of this invention for any particular truck dumper application. As shown, truck dumper 100 includes a low profile truck platform 110 pivotally mounted to a flat concrete slab 102 and a pair of hydraulic telescoping lift cylinders 150, which raise the platform between its raised and lowered positions. As shown in FIGS. 7-7, concrete slab 102 is located adjacent a below grade storage pit 103. Typically storage pit 103 contains a conveyer apparatus (not shown) for transporting the contents deposited therein to other locations and processes. Truck platform 110 and lift cylinders 150 are pivotally mounted atop slab 102 by a frame structure 104 and 106, respectively.

Lift cylinders 150 are of conventional design and include cylinder barrel 152 and a telescoping piston rod 154, which provides a piston stroke sufficient to pivot the truck platform to a 63 degree angle. Such telescoping lift cylinders are well known and understood in the art. Lift cylinders 150 are pivotally connected to frame structure 104 using conventional components and techniques.

Truck platform 110 includes a flat deck 120 mounted between a pair of parallel side beams 112. Side beams 112 are conventional steel I-beams having a flat side wall or spine 114 and integral bottom and top flanges 113 and 115. Deck 120 is constructed of metal plating 122 welded atop a metal sub frame 124. Sub-frame 124 is constructed of welded longitudinal members, cross members and braces. Deck 120 is suspended between side beams 112 with the deck seated atop and welded to the facing bottom flanges 113 of side beams 112. Truck platform 110 also includes a pair of A-frame supports mounted to each side beam at a mid point along the length of the truck platform. Truck platform 110 pivots on a shaft 116 that extends through bores in side walls 114 of side beams 112 and is supported by frame structure 104 at the pivot end of truck dumper 100. Platform pivot shaft 116 is also journalled within bearings 117 seated within the bores in side beams 112. A-frame support 118 provides an elevated connection point of the hydraulic cylinders 150. A-Frame support 118 is mounted to side beams 112 at a mid point of truck platform 110.

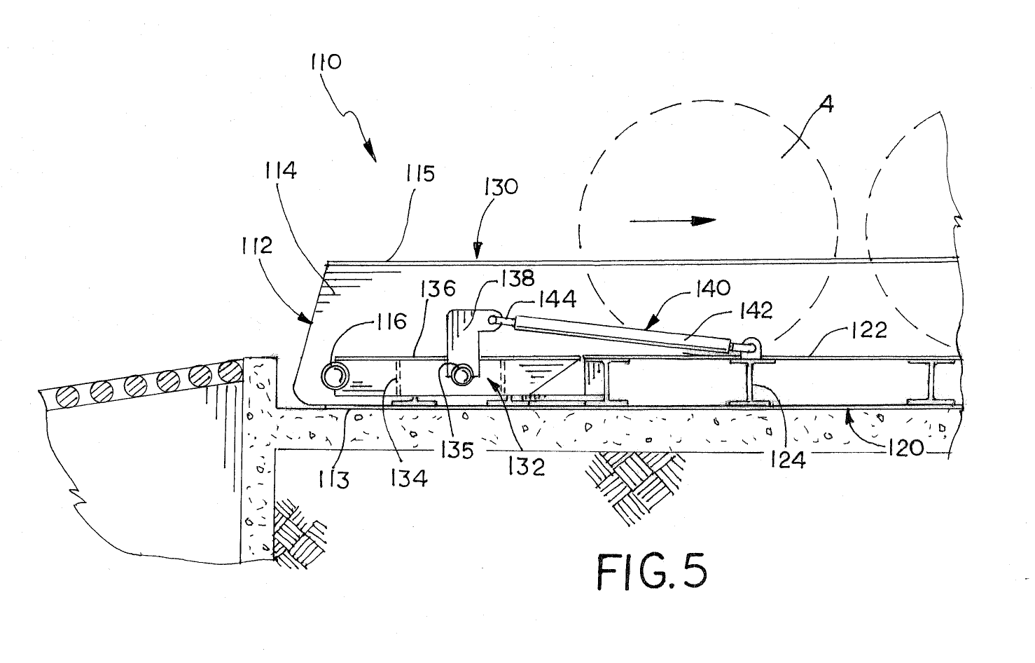

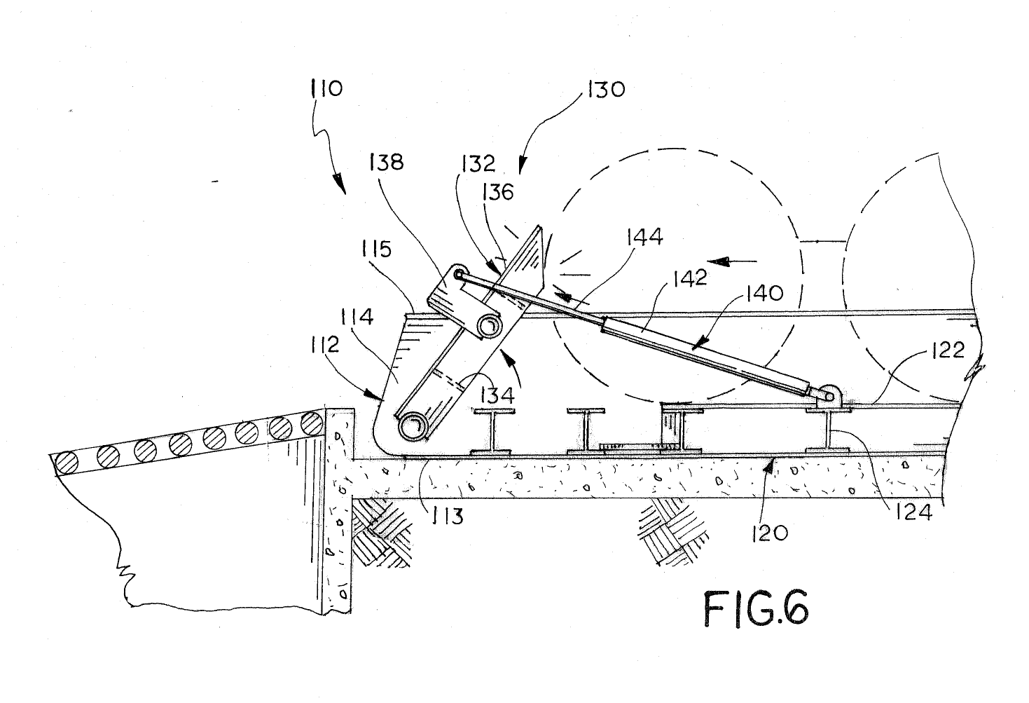

Truck platform 110 also includes a wheel chock assembly 130. Wheel chock assembly 130 includes pivoting chock deck 132 and a pair of hydraulic cylinders 140 that move the chock deck between a lowered position (FIG. 5) and a raised position (FIG. 6). In the lowered position (FIG. 5), chock deck 132 lays flat forming part of truck deck 120. In the raised position, chock deck 132 is pivoted upward about platform pivot shaft 116 so that the edge of chock deck 132 abuts the rear wheels of the truck to act as a wheel chock. Chock deck 132 includes a sub frame 134, which is welded to platform pivot shaft 116 and a flat top plate 136. Chock cylinders 140 are of conventional double action design and include a cylinder barrel 142 and a single piston rod 144, such as the Dalton Model DBH-2524 hydraulic tie-rod cylinder. Chock cylinders 140 are mounted to opposite side beams 112 and each are operatively connected to chock deck 132 by a lever arm 138 welded to the side of sub-frame 134. Chock cylinders 140 provide sufficient piston stroke to raise chock deck 132 to its raised position (FIG. 6). Chock deck sub-frame 134 also includes a cross bar 135, whose ends abut the top flanges 115 of side beams 112 when the chock deck in the raised position.

Truck dumper 100 may also include a conventional gate stop assembly (not shown) which abuts the back of the trailer to prevent the truck from rolling off the platform when lifted. Gate stop assemblies are well known in the art and therefore the description and details of such are omitted for brevity. Nevertheless, a conventional gate stop assembly may be adapted to truck dumper 100 to work in conjunction with wheel chock assembly 130 and/or as a redundant safety apparatus for securing a truck atop truck platform 110 during the dumping process.

Both lift cylinders 150 and chock cylinders 140 form part of an integrated hydraulic control system, which allows a user to independently control and actuate the cylinders in the operation of truck dumper 100. Such hydraulic control systems are well known and understood in the art. The hydraulic control system may include a variety of hydraulic pumps, control and relief valves, reservoirs, accumulators, separators, switches, alarms, gauges, displays and controls panels. Typically, the control panels and other user interfaces are located where a user can safely monitor the operation of the truck dumper as contents are being dumped from the truck into the storage pit 103.

### ADVANTAGES

One skilled in the art will note several advantages of the present invention over conventional truck dumper designs. Unlike conventional truck dumper designs where the truck decks are built atop longitudinal beams, the truck platform of this invention has a deck that is suspended between two side beams, seated atop the bottom I beam flange. In addition, the platform pivot shaft of this invention extends through the side wall of the side beams. Both of these construction features help provide a lower truck platform profile without compromising structural integrity. The lower platform profile eliminates the need for a below grade lift pit. The wheel chock assembly of this invention also provides a sturdy mechanical wheel stop without extensive structural bracing. The chock platform forms part of the truck deck and is directly connected to the pivot shaft of the truck platform providing a solid structural stop brace. The travel of the pivoting chock platform is physically braced by the abutment of the cross member against the flanges of the large side I beams.

It should be apparent from the foregoing that an invention having significant advantages has been provided. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. An apparatus for lifting and pivoting a truck to deposit the contents of the truck within a storage pit or container having an open mouth, comprising:
a flat foundation slab;
an elongated platform extending over the foundation slab and having a first end thereof pivotally connected to the foundation slab for movement between a first position where the platform lies substantially horizontal and a second position where the platfrom is pivoted at an angle over the foundation slab; and
a cylinder operatively connected to the platform and the pit structure for moving the platform between the first position and the second position,
the platform includes a pair of side beams spaced parallel to one another and a flat deck part suspended between the side beams.

2. The apparatus of claim 1 wherein each of the pair of side beams has a side wall, a top flange and a bottom flange, the deck part seated atop the bottom flanges of the pair of side beams.

3. The apparatus of claim 1 wherein the platform includes a wheel chock assembly mounted between the side beams at one end of the platform.

4. The apparatus of claim 4 wherein the wheel chock assembly includes a chock deck part pivotally connected to the platform for movement between a lowered position where the chock deck part lies flat to form part of the deck part and a raised position where the chock deck is angled with respect to the deck part, and a second cylinder operatively connected to the platform and the chock deck for moving the chock deck between the lowered position and raised position.

5. The apparatus of claim 4 wherein the platform includes a pivot shaft rotatably mounted to the pit structure, the chock deck is mounted to the pivot shaft.

6. The apparatus of claim 4 wherein the chock deck includes a member abutting the side beams when the chock deck is in the raised position.
